(19) United States
(12) Patent Application Publication
(10) Pub. No.: US 2009/0111528 A1
(43) Pub. Date: Apr. 30, 2009

(54) Method and Apparatus for an Audible Indication of an Active Wireless Link

(75) Inventors: Igor Kovalenko, Hoffman Estates, IL (US); Timothy M. McCune, Mundelein, IL (US)

Correspondence Address: LEVEQUE INTELLECTUAL PROPERTY LAW, P.C., 221 EAST CHURCH ST., FREDERICK, MD, 21701, US

(73) Assignee: MOTOROLA, INC., Schaumburg, IL (US)

(21) Appl. No.: 11/928,487

(22) Filed: Oct. 30, 2007

(51) Int. Cl. H04M 1/00

(52) U.S. Cl. 455/569.1

(57) ABSTRACT

A mobile telephone is operable to alert a user of the mobile telephone to the presence of an active wireless audio interface during a telephone call. The telephone comprises a local audio interface, having a loudspeaker and microphone, a user activity detector operable to detect user interaction with the telephone if a wireless audio interface is active, and a processor, operable to cause an audible signal to be generated by the loudspeaker of the local audio interface if a wireless audio interface is active and user activity is detected by the user activity detector. User interaction with the telephone is monitored and an audible message is played through the local audio interface of the mobile telephone if user interaction with the mobile telephone is detected and a wireless audio interface is active. The audible message alerts the user to the presence of the active wireless audio interface.

### BACKGROUND

Cellular telephones are often used with a wireless audio interface, such as a wireless headset, that is not physically connected to the telephone and communicates with it using a wireless connection. The radio link may use a standardized protocol such as the Bluetooth protocol. The wireless headset allows a user to operate the cellular telephone in a ‘hands-free’ mode while performing other activities—such as driving an automobile. In this mode, audio signals are routed through the wireless audio interface, rather than the local audio interface of the telephone, and the local audio interface of the telephone is disabled.

In normal operation, the telephone and headset are within a few feet of one another and the user interfaces with the telephone through the wireless headset. However, wireless communication is possible over much greater distances. For example, a radio connection will allow connection between a telephone in one room and a headset in a different room, or between a telephone inside a house and a headset in an automobile. This may cause a problem for the user. For example, when a cellular telephone rings and the user answers the call, the user may be unaware that the wireless audio interface—at a different location—is still active. If the user is unaware of the active wireless audio interface, he or she may believe that the lack of audio is an indication of a problem with the telephone or with the call connection.

Further, if the telephone may potentially be in communication with one of multiple wireless devices, the user may not know which device is active.

Current cellular telephones provide a visual indication of an active Bluetooth link. However, users may not notice this when answering an incoming call.

### BRIEF DESCRIPTION OF THE FIGURES

The accompanying figures, in which like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is simplified block diagram of a mobile telephone with a wireless audio interface in accordance with some embodiments of the invention.

FIG. 2 is a flow of a method for audible indication of an active wireless audio interface in accordance with some embodiments of the present invention.

FIG. 3 is a block diagram of a system for audible indication of an active wireless audio interface in accordance with some embodiments of the present invention.

FIG. 4 is a block diagram of a system for audible indication of an active wireless audio interface in accordance with further embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to audible indication of an active wireless link. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It will be appreciated that embodiments of the invention described herein may comprise one or more conventional processors and unique stored program instructions that control the one or more processors to implement, in conjunction with certain non-processor circuits, some, most, or all of the functions of audible indication of an active wireless link described herein. The non-processor circuits may include, but are not limited to, a radio receiver, a radio transmitter, signal drivers, clock circuits, power source circuits, and user input devices. As such, these functions may be interpreted as a method to perform audible indication of an active wireless link. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

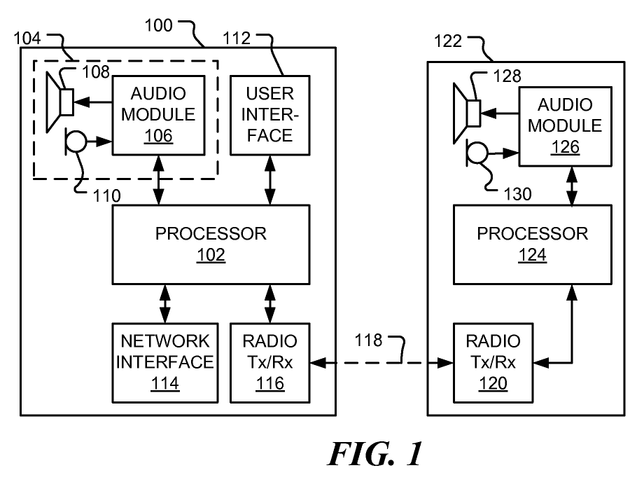

FIG. 1 is simplified block diagram of a mobile telephone with a wireless audio interface in accordance with some embodiments of the invention. The telephone 100 uses a processor 102 and a local audio interface 104 that comprises an audio module 106, loudspeaker 108 and microphone 110. The local audio interface 104 may be integrated with the electronic device or physically connected to it. An example of a physically connected interface is an audio headset connected by a plug and cable to the telephone. A further user interface 112 may include tactile user inputs such as a keyboard, a visual display and a pointing device, for example. The telephone 100 may also use a network interface 114. For example, this may be a cellular radio link, a wireless Internet link or a wired or wireless local area network link.

The telephone may a cellular telephone. It may be a dedicated device or the telephone may be incorporated into another electronic device such as a portable computer, personal digital assistant or portable media player, for example.

In a first mode of operation, the telephone operates in a ‘stand-alone’ mode in which the local audio interface 104 is activated for receiving and/or broadcasting audio. For example, user's speech is sensed by microphone 110 and the incoming audio signals are broadcast from loudspeaker 108.

In a second mode of operation, the loudspeaker 1108 of the local audio interface 104 is deactivated and a radio transceiver 116 is activated. The radio transceiver sends and receives signals over a propagation path 118 to a radio transceiver 120 of a wireless audio interface 122. The wireless audio interface 122 includes a processor 124, an audio module 126, a loudspeaker 128 and a microphone 130.

In one embodiment of the invention, the telephone comprises a cellular telephone and the wireless audio interface comprises a wireless headset. The radio link may use a custom protocol or may use a standardize protocol such as the Bluetooth protocol. This allows a user to operate the cellular telephone in a ‘hands-free’ mode while performing other activities—such as driving an automobile. In this mode, audio signals are routed through the wireless audio interface rather than the local audio interface of the telephone and the local loudspeaker is disabled.

In accordance with one embodiment of the invention, the telephone 100 is operable to determine if a user is attempting to use the local audio interface when the wireless audio interface is active and generates an audible warning to alert the user when this happens.

One embodiment of the present invention relates to a method for alerting a mobile telephone user to the presence of an active wireless audio interface during a telephone call. User interaction with the mobile telephone is monitored if a wireless audio interface is active and an audible message is played through a local audio interface of the mobile telephone if user interaction with the mobile telephone is detected and a wireless audio interface is active. The audible message alerts the user to the presence of the active wireless audio interface.

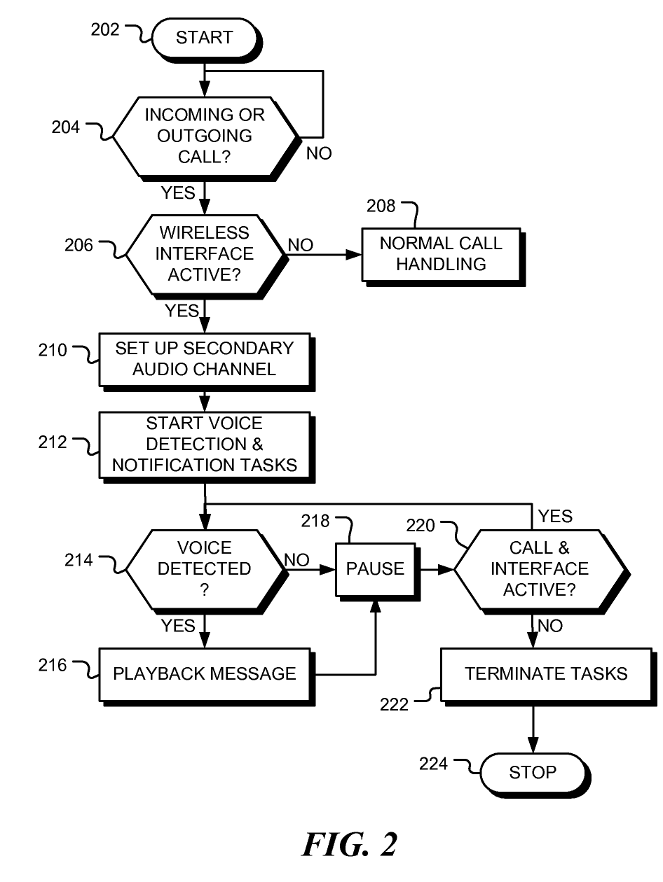

FIG. 2 is a flow of a method for audible indication of an active wireless audio interface in accordance with some embodiments of the present invention. Following start block 202 in FIG. 2, the method begins, as depicted by the positive branch from decision block 204, when an incoming is answered or an outgoing call is commenced. At decision block 206 the telephone determines if a wireless audio interface is active. If no wireless audio interface is active, as depicted by the negative branch from decision block 206, the call is handled in the normal manner at block 208. If a wireless audio interface is active, as depicted by the positive branch from decision block 206, a secondary audio channel is setup at block 210, which allows the audio signals to be routed to the wireless audio interface. In prior systems, the assumption is that the wireless interface will be used. In accordance with one embodiment of the present invention, the telephone monitors user activity to determine if the user is attempting to use the local audio interface rather than the wireless audio interface. In the embodiment shown in FIG. 2, the telephone starts voice detection and notification tasks at block 212. In the voice detection task, the microphone output of the local audio interface is monitored to detect voice activity. If voice activity is detected at the local microphone, as depicted by the positive branch from decision block 214, an audible message is played to the user from the local loudspeaker at block 216. This message may be a warning with a prompt for the user to switch to the local audio interface. Alternatively, the message may be a warning that the telephone has switched to the local audio interface, so as to allow the user to override the wireless interface if desired. The message may also identify the wireless audio interface that is active. This may be done, for example, using a text-to-speech engine of the telephone. Alternatively, the identification may be displayed visually.

The level of voice detected may be compared with level from the active wireless audio interface so as to determine which audio interface the user is trying to use.

If no voice activity is detected, as depicted by the negative branch from decision block 214, or once the message has been played back, the process pauses at block 218. Then, as decision block 220, a check is made to determine if the call and the wireless interface are still active. If the call has finished or the wireless audio interface has been deactivated, as depicted by the negative branch from decision block 222, the detection and notification tasks are terminated at block 222 and the process ends at block 224. If the call and the wireless interface are still active, as depicted by the positive branch from decision block 222, flow returns to block 214 to determine if the user again attempts to user the local audio interface rather than the wireless audio interface.

In further embodiments, other methods are used to detect user attempts to use the local audio interface when the wireless interface is active.

In one embodiment, a sensor, such as a proximity sensor, is used to determine if a user has opened the cover of the telephone and where it is being held with respect to the user's body. Such sensors are currently used in telephones. Opening of the cover may indicate that the user is about to answer or place a call and proximity sensor may indicate whether the user is attempting to use the local audio interface.

In a further embodiment, user pressing of a ‘call’, ‘send’ or ‘answer’ button on a keyboard or touch-screen, together with data from the proximity sensor, may be used to indicate that the user is about to use the local audio interface while a wireless audio interface is active.

A tactile interface of the telephone (such as a keypad, touch screen or pointing device, for example) may be used as a user activity detector.

A voice level detector may be used as a user activity detector.

Other means of detecting user attempts to use the local audio interface while the wireless interface is active will be apparent to those of ordinary skill in the art.

A further embodiment of the present invention relates to a mobile telephone that is able to alert a user of the mobile telephone to the presence of an active wireless audio interface during a telephone call. The mobile telephone includes a local audio interface having a loudspeaker and microphone and a radio transceiver, operable to form a radio link between the mobile telephone and the active wireless audio interface. The telephone also includes a user activity detector operable to detect user interaction with the mobile telephone if a wireless audio interface is active and a processor that is responsive to the user activity detector and is operable to cause an audible signal to be generated by the loudspeaker of the local audio interface if a wireless audio interface is active and user activity is detected by the user activity detector.

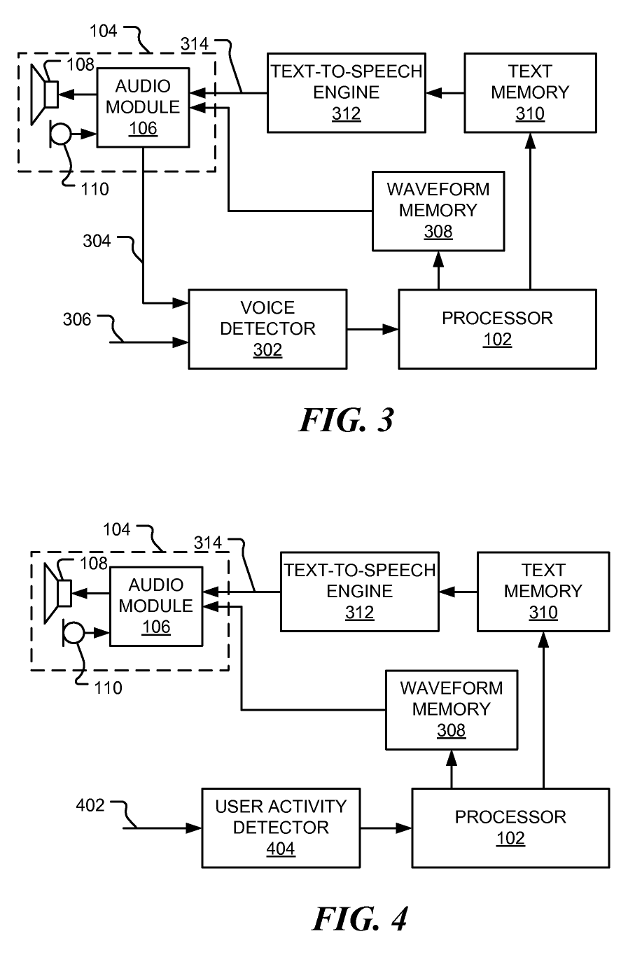

FIG. 3 is a block diagram of a system for audible indication of an active wireless audio interface in accordance with some embodiments of the present invention. In FIG. 3, a voice detector 302 receives a signal 304 from the microphone 110 via the audio module 106 of the local audio interface 104 of the telephone. Optionally, the voice detector 302 may also receive a signal 306 from a remote wireless audio interface for comparison with the signal 304. If a voice signal is detected at the local microphone, the voice detector 302 signals the processor 102. If a wireless audio interface is active, the processor responds, in accordance with method shown in FIG. 2, by initiating an audible warning to the user. This may be done by causing waveforms from a waveform memory 308 to be passed to the loudspeaker 108 of the local audio interface 104. The waveforms may represent speech or other sounds. Alternatively, or additionally, the processor may cause text messages stored in a text memory 310 to be passed to a text-to-speech engine 312. The text-to-speech engine 312 outputs waveforms 314 that are passed to the loudspeaker 108 of the local audio interface 104 and broadcast to the user. It this manner the user is alerted to the presence of an active wireless audio interface and may be provided with an identification of the wireless device in use.

FIG. 4 is a block diagram of a system for audible indication of an active wireless audio interface in accordance with further embodiments of the present invention. In FIG. 4, a user activity event signal 302 is passed to a user activity detector 404. The user event, as described above, may be the opening of the cover of the telephone or other user interaction with the telephone. If user activity is detected, the user activity 404 detector signals the processor 102. If a wireless audio interface is active, the processor responds, in accordance with method shown in FIG. 2, by initiating an audible warning to the user. This may be done by causing waveforms from a waveform memory 308 to be passed to the loudspeaker 108 of the local audio interface 104. The waveforms may represent speech or other sounds. Alternatively, or additionally, the processor may cause text messages stored in a text memory 310 to be passed to a text-to-speech engine 312. The text-to-speech engine 312 outputs waveforms 314 that are passed to the loudspeaker 108 of the local audio interface 104 and broadcast to the user. It this manner the user is alerted to the presence of an active wireless audio interface and may be provided with an identification of the wireless device in use. The audible alert may be accompanied by visual information relating to the nature of the alert.

The method of the present invention may be implemented, for example, on a programmed processor of the telephone, on a programmable logic device (such as a field programmable gate array) or on an application specific integrated circuit.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for alerting a mobile telephone user to the presence of an active wireless audio interface during a telephone call, the method comprising:
monitoring user interaction with the mobile telephone if a wireless audio interface is active; and
playing an audible message through a local audio interface of the mobile telephone if user interaction with the mobile telephone is detected and a wireless audio interface is active;
wherein the audible message alerts the user to the presence of the active wireless audio interface.

2. A method in accordance with claim 1, further comprising identifying the active wireless audio interface in the audible message.

3. A method in accordance with claim 2, further comprising generating at least a portion of the audible message using a text-to-speech engine.

4. A method in accordance with claim 1, further comprising identifying the active wireless audio interface in a visual display of the mobile telephone.

5. A method in accordance with claim 1, further comprising the mobile telephone communicating with the wireless audio interface via a Bluetooth radio connection.

6. A method in accordance with claim 1, further comprising, while the wireless audio interface and telephone call remain active, playing the audible message through a local audio interface of the mobile telephone at predetermined time intervals.

7. A method in accordance with claim 1, wherein monitoring user interaction with the mobile telephone if a wireless audio interface is active comprises:
monitoring a signal from a microphone of the local audio interface; and
detecting the presence of voice signal in the signal from the microphone of the local audio interface.

8. A method in accordance with claim 7, wherein monitoring user interaction with the mobile telephone further comprises comparing the signal from a microphone of the local audio interface with a signal from a microphone of the active wireless audio interface.

9. A method in accordance with claim 1, wherein monitoring user interaction with the mobile telephone if a wireless audio interface is active comprises:
detecting if a cover of the mobile telephone is opened; and
using proximity sensor data to determine the mobile telephone's position with respect to the user's body.

10. A method in accordance with claim 1, wherein monitoring user interaction with the mobile telephone if a wireless audio interface is active comprises detecting if the user makes or answers a telephone call.

11. A method in accordance with claim 1, further comprising
if user interaction with the mobile telephone is detected and a wireless audio interface is active:
activating the local audio interface; and
deactivating the wireless audio interface.

12. A method in accordance with claim 11, further comprising prompting the user to reactive the wireless audio interface.

13. A method in accordance with claim 1, further comprising prompting the user to determine if the local audio interface should be activated and the wireless audio interface deactivated.

14. A mobile telephone operable to alert a user of the mobile telephone to the presence of an active wireless audio interface during a telephone call, the mobile telephone comprising:
a local audio interface comprising a loudspeaker and microphone;
a radio transceiver, operable to form a radio link between the mobile telephone and the active wireless audio interface;
a user activity detector operable to detect user interaction with the mobile telephone if a wireless audio interface is active; and
a processor, responsive to the user activity detector and operable to cause an audible signal to be generated by the loudspeaker of the local audio interface if a wireless audio interface is active and user activity is detected by the user activity detector.

15. A mobile telephone in accordance with claim 14, further comprising a waveform memory operable to store at least one signal waveform to be passed to the local audio interface for conversion to an audible signal if a wireless audio interface is active and user activity is detected by the user activity detector.

16. A mobile telephone in accordance with claim 14, further comprising:
a text memory operable to store at least one text message; and
a text-to-speech engine operable to generate, from a text message of the at least one text message, a waveform to be passed to the local audio interface for conversion to an audible signal if a wireless audio interface is active and user activity is detected by the user activity detector.

17. A mobile telephone in accordance with claim 14, wherein the user activity detector comprises a voice detector responsive to a signal from the microphone of the local audio interface.

18. A mobile telephone in accordance with claim 14, wherein the user activity detector comprises a sensor operable to detect when a cover of the mobile telephone is opened.

19. A mobile telephone in accordance with claim 14, wherein the user activity detector comprises a proximity sensor operable to detect the mobile telephone's position with respect to the user's body.

20. A mobile telephone in accordance with claim 14, wherein the user activity detector comprises a voice level detector.

21. A mobile telephone in accordance with claim 14, wherein the user activity detector comprises a tactile interface of the mobile telephone.

22. A mobile telephone in accordance with claim 14, wherein the local audio interface is integrated with the mobile telephone.

23. A mobile telephone in accordance with claim 14, wherein the local audio interface is a wired headset of the mobile telephone.
